(19) United States
(12) Patent Application Publication
(10) Pub. No.: US 2012/0013299 A1
(43) Pub. Date: Jan. 19, 2012

(54) Controller for a modular system for charging electrical vehicles

(75) Inventors: Ronald Prosser, Brooklyn, NY (US); Stephen M. Burchett, Brooklyn, NY (US)

(73) Assignee: The Prosser Group LLC

(21) Appl. No.: 13/066,615

(22) Filed: Apr. 19, 2011

Related U.S. Application Data
(60) Provisional application No. 61/399,491, filed on Jul. 13, 2010.

(51) Int. Cl. H02J 7/00

(52) U.S. Cl. 320/109

(57) ABSTRACT

A controller for utilizing real-time surplus electrical energy available from a facility in which a modular system for charging electrical vehicles operates to allow more chargers to be installed and operational at the facility while avoiding costly and time-consuming infrastructure upgrades. The controller includes an EV charger interface, a facility energy management interface, and a distribution grid interface. The EV charger interface bidirectionally interfaces with EV chargers. The facility energy management interface bidirectionally interfaces with a facility electrical monitoring system, and receives real-time current usage readings from the facility electrical monitoring system, and in response thereto, either cycles the EV chargers—via the EV charger interface—on or off to modulate power used at any point in time to stay within overall limits of the facility or reduces EV charging rate in order to make use of any unused electricity on a real-time basis so as to allow more chargers to be installed and operational at the facility while avoiding the costly and time-consuming infrastructure upgrades. The distribution grid interface bidirectionally interfaces with an electrical distribution grid electrically feeding the facility.

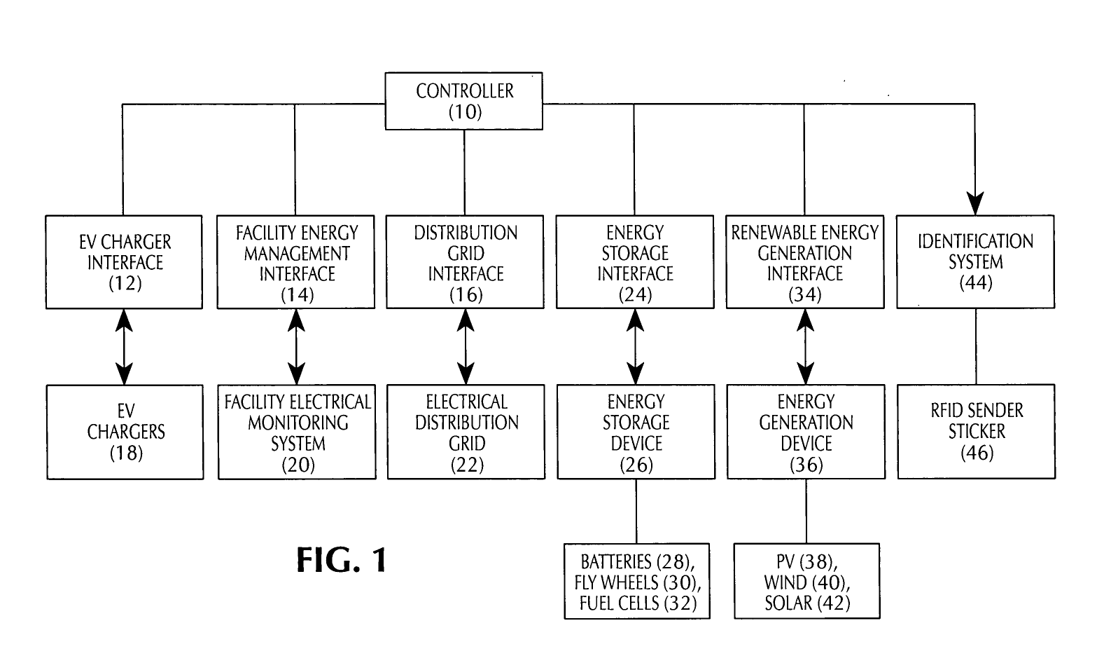

### 1. CROSS REFERENCE TO RELATED APPLICATIONS

The instant non-provisional patent application claims priority from provisional patent application No. 61/399,491, filed on Jul. 13, 2010, for CONTROLLER FOR ELECTRIC VEHICLE CHARGING SYSTEMS, and incorporated herein by reference thereto.

### 2. BACKGROUND OF THE INVENTION

A. Field of the Invention

The embodiments of the present invention relate to a controller for a system for charging an electrical vehicle, and more particularly, the embodiments of the present invention relate to a controller for utilizing real-time surplus electrical energy available from a facility in which a modular system for charging electrical vehicles operates to allow more chargers to be installed and operational at the facility while avoiding costly and time-consuming infrastructure upgrades.

B. Description of the Prior Art

The electric vehicle (“EV”) market in the United States and around the world is expected to increase markedly by 2020. These projections are based on economic factors, such as the increasing cost of gasoline at the pumps and environmental impacts of continued use of high levels of fossil fuel as evidenced by the recent petroleum releases in the Gulf of Mexico.

EV charging, however, places an additional load on building systems and the local electrical distribution grid. Most buildings have limitations on their electrical service capacity due to the cost the utility has to absorb to initially provide an infrastructure to buildings and facilities. The same is true of the limited capacity of a local secondary distribution grid. Typically, utilities use rules of thumb to determine the amount of electrical service to provide to the building and its accompanying infrastructure. Simply adding up individual maximum loads and calculating the service capacity required results in over designing electrical supply by a factor of 3 or 4. These costs are passed on to ratepayers, and as such, are deemed to be an unnecessary burden. As a consequence today, many buildings and facilities operate at 70% or 80% of its rated capacity.

The addition of commercial EV charging could effectively double electrical loads in facilities where a large number of EVs are expected to be parked. This may occur during the day for commuters at or near offices, in the evening in apartment complexes, and at other times of the day at facilities servicing EV charging needs including convenience stores, quick service restaurants, sports arenas, etc.

In order to maximize the time and cost impacts of upgrading an infrastructure, the need exists to maximize the capability of existing infrastructure to accommodate these new electrical loads. Thus, there exists a need for a controller for utilizing real-time surplus electrical energy available from a facility in which a modular system for charging electrical vehicles operates to allow more chargers to be installed and operational at the facility while avoiding costly and time-consuming infrastructure upgrades.

Numerous innovations for power-related devices have been provided in the prior art, which will be described below in chronological order to show advancement in the art, and which are incorporated herein by reference thereto. Even though these innovations may be suitable for the specific individual purposes to which they address, nevertheless, they differ from the embodiments of the present invention in that they do not teach a controller for utilizing real-time surplus electrical energy available from a facility in which a modular system for charging electrical vehicles operates to allow more chargers to be installed and operational at the facility while avoiding costly and time-consuming infrastructure upgrades.

(1) U.S. Pat. No. 5,184,058 to Hesse et al.

U.S. Pat. No. 5,184,058 issued to Hesse et al. on Feb. 2, 1993 in U.S. class 320 and subclass 4 teaches a method and system for storing electrical energy, and then using the stored energy to recharge automobiles. The system features a number of storage and recharging facilities that are connected to a main power generating station. Power is generally demanded from the power station in the evening or during off-peak power demand periods in order to obtain lower rates from the power utility. Also, off-peak power loading does not put a strain on the power system. The energy obtained from the power utility company is then stored at each recharging facility in a bank of capacitors. A high voltage transformer and rectifier arranged ahead of the capacitor banks convert the incoming AC high voltage power from the utility to the required DC voltage for capacitor storage. The controller distributes power to a number of charging bays that are connected to the capacitor bank. A vehicle needing charging pulls into an individual bay in the recharging facility, and is connected to a metering device having a feedback control. A sensing unit interrogates the power remaining in the batteries of the vehicle, and passes this information onto a controller. In this manner, the exact amount of required energy is transferred to the vehicle.

(2) U.S. Pat. No. 5,394,016 to Hickey.

U.S. Pat. No. 5,394,016 issued to Hickey on Feb. 28, 1995 in U.S. class 290 and subclass 55 teaches a solar and wind energy generating system for mounting to a building, which includes a wind generator system including at least an auger-shaped air-engaging member. A plurality of wind generators have air-engaging vanes. The wind generating system intercepts the flow of air currents to produce mechanical energy that is transformed into electrical energy by an electric generator. The air-engaging surface of the wind generator vanes or the auger include a plurality of surface deviations. The surface deviations are arranged in at least one predetermined pattern, such as a plurality of radially extending deviation sets. The solar generator includes a plurality of solar energy collectors. The wind generators further include air-engaging vanes having at least one transparent surface, and a plurality of solar energy collectors within a cavity formed in the vane, thus forming a combined solar and wind energy generator. The wind and solar generators are stored within the building when not in use, and are movable to a position exterior of the building when in use. The wind and solar energy generating system is vertically or horizontally mounted, on or off a pedestal, and is surrounded by a net-like structure to prevent harm to birds.

(3) U.S. Pat. No. 5,803,215 to Henze et al.

U.S. Pat. No. 5,803,215 issued to Henze et al. on Sep. 8, 1998 in U.S. class 191 and subclass 2 teaches a method and apparatus for charging batteries of a plurality of vehicles, which includes a power source converter connectable to a power source to receive electrical power, and for converting the electrical power to a selected voltage potential that is distributed on a distribution bus. A plurality of vehicle connecting stations are connected to the distribution bus. Each vehicle connecting station includes a station power converter for receiving electrical power from the power source converter for charging the battery, and a station controller to control electrical power flow to the vehicle battery.

(4) U.S. Pat. No. 5,926,004 to Henze.

U.S. Pat. No. 5,926,004 issued to Henze on Jul. 20, 1999 in U.S. class 320 and subclass 109 teaches a method and an apparatus for charging one or more electric vehicles, which includes a first power converter and a second power converter connectable to a source of electric power to receive electric power therefrom. A switch selectively connects the power converters together to provide combined power to a first power coupler in order to charge one electric vehicle, or connects the power converters to separate power couplers in order to charge a plurality of vehicles.

(5) U.S. Pat. No. 6,590,363 B2 to Teramoto.

U.S. Pat. No. 6,590,363 B2 issued to Teramoto on Jul. 8, 2003 in U.S. class 320 and subclass 101 teaches a wind power generator that is enclosed at the center of a duct. The duct includes upper and lower duct panels having solar panels. The distance between the upper and lower duct panels is smallest at the center where the wind power generator is mounted. The distance gradually increases as the upper and lower duct panels extend further away from the wind power generator. Thus, the duct collects wind blowing toward the wind power generator, and increases the speed of the collected wind thereby achieving an increase in the quantity of power generated in the wind power generator.

### (6) United States Patent Application Publication Number US 2008/0039980 A1 to Pollack et al.

United States Patent Application Publication Number US 2008/0039980 A1 published to Pollack et al. on Feb. 14, 2008 in U.S. class 700 and subclass 295 teaches systems and methods for a power aggregation system. In one implementation, a service establishes individual Internet connections to numerous electric resources intermittently connected to a power grid, such as electric vehicles. The Internet connection is made over the same wire that connects the resource to the power grid. The service optimizes power flow to suit needs of each resource and each resource owner, while aggregating flows across numerous resources to suit needs of the power grid. The service brings vast numbers of electric vehicle batteries online as a dynamically aggregated power resource for the power grid. Electric vehicle owners participate in an electricity-trading economy, regardless of where they plug into the power grid.

### (7) United States Patent Application Publication Number US 2010/0045232 A1 to Chen et al.

United States Patent Application Publication Number US 2010/0045232 A1 published to Chen et al. on Feb. 25, 2010 in U.S. class 320 and subclass 109 teaches a modularized interface for connecting a plug-in electric vehicle to an energy grid. For use with public or semi-public outlets, the modularized interface includes a module and a smart socket. The module is integrated within, or capable of being connected to, the vehicle's charging interface. The module is normally disabled, but is enabled only: after the end user is authenticated; the smart socket and its associated meter have been identified; and, the module and the end user's account with the local utility are validated. The module meters the energy consumption, and when the module is disconnected from the smart socket indicating termination of the charging session, the metered data is communicated to the utility for updating the end user's account, and the module is disabled. The module is also capable of use with conventional outlets located, for example, in private residences.

It is apparent that numerous innovations for power-related devices have been provided in the prior art, which are adapted to be used. Furthermore, even though these innovations may be suitable for the specific individual purposes to which they address, nevertheless, they would not be suitable for the purposes of the present invention as heretofore described, namely, a controller for utilizing real-time surplus electrical energy available from a facility in which a modular system for charging electrical vehicles operates to allow more chargers to be installed and operational at the facility while avoiding costly and time-consuming infrastructure upgrades.

### 3. SUMMARY OF THE INVENTION

Thus, an object of the embodiments of the present invention is to provide a controller for utilizing real-time surplus electrical energy available from a facility in which a modular system for charging electrical vehicles operates to allow more chargers to be installed and operational at the facility while avoiding costly and time-consuming infrastructure upgrades, which avoids the disadvantages of the prior art.

Briefly stated, another object of the embodiments of the present invention is to provide a controller for utilizing real-time surplus electrical energy available from a facility in which a modular system for charging electrical vehicles operates to allow more chargers to be installed and operational at the facility while avoiding costly and time-consuming infrastructure upgrades. The controller includes an EV charger interface, a facility energy management interface, and a distribution grid interface. The EV charger interface bidirectionally interfaces with EV chargers. The facility energy management interface bidirectionally interfaces with a facility electrical monitoring system, and receives real-time current usage readings from the facility electrical monitoring system, and in response thereto, either cycles the EV chargers—via the EV charger interface—on or off to modulate power used at any point in time to stay within overall limits of the facility or reduces EV charging rate in order to make use of any unused electricity on a real-time basis so as to allow more chargers to be installed and operational at the facility while avoiding the costly and time-consuming infrastructure upgrades. The distribution grid interface bidirectionally interfaces with an electrical distribution grid electrically feeding the facility.

The novel features considered characteristic of the embodiments of the present invention are set forth in the appended claims. The embodiments of the present invention themselves, however, both as to their construction and to their method of operation together with additional objects and advantages thereof will be best understood from the following description of specific embodiments when read and understood in connection with the accompanying FIGURE of the drawing.

### 4. BRIEF DESCRIPTION OF THE FIGURE OF THE DRAWING

The sole FIGURE of the drawing is a diagrammatic block diagram of the controller of the embodiments of the present invention utilizing real-time surplus electrical energy available from a facility in which a modular system for charging electrical vehicles operates to allow more chargers to be installed and operational at the facility while avoiding costly and time-consuming infrastructure upgrades.

### 5. LIST OF REFERENCE NUMERALS UTILIZED IN THE FIGURE OF THE DRAWING

### A. General.

10 controller of embodiments of present invention for utilizing real-time surplus electrical energy available from facility in which modular system for charging electrical vehicles operates to allow more chargers to be installed and operational at facility while avoiding costly and time-consuming infrastructure upgrades

### B. Configuration of Controller 10.

12 EV charger interface for bidirectionally interfacing with EV chargers 18
14 facility energy management interface for bidirectionally interfacing with facility electrical monitoring system 20
16 distribution grid interface for bidirectionally interfacing with electrical distribution grid 22 electrically feeding facility
18 EV chargers
20 facility electrical monitoring system
22 electrical distribution grid
24 energy storage interface for bidirectionally interfacing with energy storage device 26
26 energy storage device
28 batteries of energy storage device 26
30 fly wheels of energy storage device 26
32 fuel cells of energy storage device 26
34 renewable energy generation interface for bidirectionally interfacing with renewable energy generation device 36
36 renewable energy generation device
38 PV of renewable energy generation device 36
40 wind of renewable energy generation device 36
42 solar of renewable energy generation device 36
44 identification system
46 RFID sender sticker of identification system 44

### 6. DETAILED DESCRIPTION OF THE PREFERRED EMBODIMENTS

### A. General.

Referring now to the sole FIGURE, which is a diagrammatic block diagram of the controller of the embodiments of the present invention utilizing real-time surplus electrical energy available from a facility in which a modular system for charging electrical vehicles operates to allow more chargers to be installed and operational at the facility while avoiding costly and time-consuming infrastructure upgrades, the controller of the embodiments of the present invention is shown generally at 10 for utilizing real-time surplus electrical energy available from a facility in which a modular system for charging electrical vehicles operates to allow more chargers to be installed and operational at the facility while avoiding costly and time-consuming infrastructure upgrades.

### B. Configuration of the Controller 10.

The controller 10 comprises an EV charger interface 12, a facility energy management interface 14, and a distribution grid interface 16.

The EV charger interface 12 is for bidirectionally interfacing with EV chargers 18. The facility energy management interface 14 is for bidirectionally interfacing with a facility electrical monitoring system 20, and receives real-time current usage readings from the facility electrical monitoring system 20,¹ and in response thereto, cycles the EV Supplied by Agilewaves, Inc.; 3499 Edison Way; Menlo Park, Calif. 94025; 650.839.0170 TEL; 650.249.5502 FAX. chargers 18 on or off to modulate power used at any point in time to stay within overall limits of the facility, or reduces EV charging rate in order to make use of any unused electricity on a real-time basis.

The Average Daily Available kWh (ADA_{kWh}) is the average of the Daily Available kWh(DA_{kWh}) calculated by integrating the real-time instantaneous available kW at the facility location. The facility electrical monitoring system 20 supplies real-time current usage readings.

The facility's Maximum Daily kWh Capacity is the maximum continuous kW rating that can be consumed in a 24-hour period. Typically, any kW rating is in terms of amps of current at a given voltage, usually 220 or 440 Volts.

$${DA}_{kWh} = {\int }_{00 \text{:} 01}^{23 \text{:} 59} {kW}_{RT} d t = {V}_{SYS} * ( {I}_{MAX} - {\int }_{00 \text{:} 01}^{23 \text{:} 59} {I}_{RT} d t )$$

where kW_{RT}=Real-Time Measured facility kW Usage

V_{SYS}=System Voltage

I_{MAX}=Maximum Allowable facility Current Capacity

I_{RT}=Real-Time Measured facility Current Usage

ADA_{kWh}={(DA_{kWh})₁+ . . . (DA_{kWh})ₙ}/n

where (DA_{kWh})₁=DA_{kWh} for a given day

n=number of days over which the average is calculated

The distribution grid interface 16 is for bidirectionally interfacing with an electrical distribution grid 22 electrically feeding the facility.

The controller 10 further comprises an energy storage interface 24. The energy storage interface 24 is for bidirectionally interfacing with an energy storage device 26, such as batteries 28, fly wheels 30, fuel cells 32, etc.

The controller 10 further comprises a renewable energy generation interface 34. The renewable energy generation interface 34 is for bidirectionally interfacing with a renewable energy generation device 36, such as PV 38, wind 40, solar 42, etc.

The controller 10 further comprises an identification system 44. The identification system 44 is for automatically identifying the electrical vehicles being charged to simplifying billing process.

The controller 10 equalizes electrical consumption of the facility when consumption of the facility fluctuates significantly by filling in valleys in consumption by utilizing the EV chargers 18—via the EV charger interface 12.

The controller 10 modulates EV charging to stay within limits of the electrical system of the facility by continuously monitoring how much unused capacity is available and applying that available capacity to EV charging and/or other related needs so as to assure that load individually circuit breakers are exposed to don't exceed their ratings and that overall service to the facility does not exceed its limits.

The controller 10 also has the ability to reduce facility electrical usage by reducing energy consumption using a rules based system. In this way, thermostats may by turned up, elevator usage restricted, etc. based on a predetermined prioritized rules based approach specific to that facility.

### C. The Energy Storage Interface 24.

The controller 10—via the energy storage interface 24—allows for the energy storage device 26 to charge the EV chargers 18 at night and be available for use during peak load periods when facility power or local grid power is not available in sufficient amounts to meet needs.

The controller 10—via the energy storage interface 24—further allows for the energy storage device 26 to also be charged up any instant when sufficient facility power is available. For example, the controller 10 allows both EV charging and energy storage recharging to occur at any time if sufficient electrical supply is available.

The controller 10—via the energy storage interface 24—further allows for the energy storage device 26 to provide electricity to EV charging in preference to using facility power when determined optimal. Stored energy may also be used in combination with facility power to charge the electrical vehicles thus reducing load that the facility would otherwise see.

The controller 10—via the energy storage interface 24—further allows for the energy storage device 26 to be used to power facility systems based on economic criteria, and during some periods, the energy storage interface 24 determines that it may be economical to curtail EV charging in whole or in part and export power into the electrical distribution grid 22—via the distribution grid interface 16.

The controller 10—via the energy storage interface 24—in periods of no EV charging demand is for utilizing the energy storage device 26 to charge the electrical distribution grid 22—via the distribution grid interface 16—or use energy for other facility energy uses in preference to paying for power from the electrical distribution grid 22.

### (1) Sizing the Energy Storage Device 26.

The energy storage device 26 can supply a certain amount of energy (kW) for a certain period of time (hours). The capacity is in terms of kWh, and is equal to the energy supply in kW multiplied by the discharge duration in hours.

### (2) kW Sizing.

In a properly sized energy storage system, the kW rating should be equal to the EV charging capacity in kW, which the energy storage supports.

For example:
If one (1) level 3 EV charger is installed that draws 60 kW while charging EVs, than a 60 kW energy storage system should be used; and
If four (4) level 2 EV chargers are installed that draw 7 kW each, than a 28 kW energy storage system should be used.

### (3) Discharge Duration Sizing.

In a properly sized energy storage system, the discharge duration is a function of probable power from other sources during high load periods. These sources may include facility power and include:
The effect of any curtailment obligation the facility may have to the utility;
On-site distributed generation, such as solar PV of CHP; and
Other arbitrage related options that include price-sensitive load-shedding on the local secondary distribution grid vs. probable EV charging requirements and other loads.

Because of the effect of recharging at periods of low electrical usage throughout the day (night and targets of opportunity periods during the day), the energy storage device 26 sees more than one cycle per day, which potentially could reduce the sizing on the order of 50%.

### D. The Renewable Energy Generation Interface 34.

The controller 10—via the renewable energy generation interface 34—is for adding the renewable energy generation devices 36 on a modular basis, which supplies electricity to charge the electric vehicles, charge batteries, power facility loads, or export power to the electrical distribution grid 22—via the distribution grid interface 16.

The controller 10—via the renewable energy generation interface 34—senses power quality and ensures that the distribution grid interface 16 is not exporting power to the electrical distribution grid 22 or being used in the facility in a manner that would damage electrical equipment.

### E. The Distribution Grid Interface 16.

The controller 10—via the distribution grid interface 16—is for reacting to electrical supply signals including electrical pricing signals and local electrical congestion of the electrical distribution grid 22.

The controller 10 is for acting as an automatic arbitrage for the electrical distribution grid 22—via the distribution grid interface 16—and for the facility—via the facility energy management interface 14—so as to allow the energy storage device 26—via the energy storage interface 24—to reduce operational costs, improve reliability of the electrical distribution grid 22—via the distribution grid interface 16, and accomplish daily load peak shaving. The controller 10 buys and sells electricity depending upon local marginal bus price of electricity.

The controller 10—via the distribution grid interface 16—is for curtailing energy use by large commercial customers on the electrical distribution grid 22. The controller 10—via the facility energy management interface 14—is for curtailing facility loads based on price signals and/or other considerations to reduce localized grid congestion, shave peak loads, and reduce operational costs.

### F. The EV Charger Interface 12.

The controller 10—via the EV charger interface 12—is for maximizing EV charging by curtailing facility load in favor of EV charging loads.

The controller 10—via the EV charger interface 12—is for maximizing number of electrical vehicles that are charged in a given time period and with a given amount of electrical power supply—via the distribution grid interface 16 and/or the renewable energy generation interface 34.

The controller 10 is for calculating charging order of the electrical vehicles based on customer-provided expected parking durations, current % charge of each electrical vehicle, and available electrical power so as to allow the number of electrical vehicles charged in a given period with a given amount of power to be automated and provide instructions to parking/charging attendants or to automatically coordinate fleets of single chargers installed in the facility.

### G. The Identification System 44.

The identification system 44 comprises an RFID sender sticker 46. The RFID sender sticker 46 of the identification system 44 is generally doughnut-shaped, is for holding electrical vehicle owner identification and billing information, and is for placing on the electrical vehicle around the female EV charger connection, formally called the gas tank cap.

The RFID sender sticker 46 of the identification system 44 is for interfacing with an EV charging handle having an RFID receiver that activates the RFID sender sticker 46 when the EV charging handle is inserted into the female EV charger connection, thus identifying each electrical vehicle at point of charging.

### H. Impressions.

It will be understood that each of the elements described above or two or more together may also find a useful application in other types of constructions differing from the types described above.

While the embodiments of the present invention has been illustrated and described as embodied in a controller for utilizing real-time surplus electrical energy available from a facility in which a modular system for charging electrical vehicles operates to allow more chargers to be installed and operational at the facility while avoiding costly and time-consuming infrastructure upgrades, however, it is not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A controller for utilizing real-time surplus electrical energy available from a facility in which a modular system for charging electrical vehicles operates to allow more chargers to be installed and operational at the facility while avoiding costly and time-consuming infrastructure upgrades, comprising:
a) an EV charger interface;
b) a facility energy management interface; and
c) a distribution grid interface;
wherein said EV charger interface is for bidirectionally interfacing with EV chargers;
wherein said facility energy management interface is for bidirectionally interfacing with a facility electrical monitoring system;
wherein said facility energy management interface is for receiving real-time current usage readings from the facility electrical monitoring system, and in response thereto, does at least one of:
I) cycles EV chargers, via the EV charger interface, on or off to modulate power used at any point in time to stay within overall limits of the facility; and
ii) reduces EV charging rate in order to make use of any unused electricity on a real-time basis; and
wherein said distribution grid interface is for bidirectionally interfacing with an electrical distribution grid electrically feeding the facility.

2. The controller of claim 1, wherein said controller equalizes electrical consumption of the facility when consumption of the facility fluctuates significantly by filling in valleys in consumption by utilizing the EV chargers, via said EV charger interface.

3. The controller of claim 1, wherein said controller modulates EV charging to stay within limits of electrical system of the facility by continuously monitoring how much unused capacity is available and applying that available capacity to EV charging and/or other related needs so as to assure that load individually circuit breakers are exposed to don't exceed their ratings and that overall service to the facility does not exceed its limits.

4. The controller of claim 1, further comprising an energy storage interface; and wherein said energy storage interface is for bidirectionally interfacing with an energy storage device.

5. The controller of claim 4, wherein said energy storage device is selected from the group consisting of batteries, fly wheels, fuel cells, and combinations thereof.

6. The controller of claim 1, further comprising a renewable energy generation interface; and
wherein said renewable energy generation interface is for bidirectionally interfacing with a renewable energy generation device.

7. The controller of claim 6, wherein said renewable energy generation device is selected from the group consisting of PV, wind, solar, and combinations thereof.

8. The controller of claim 4, wherein said controller, via said energy storage interface, is for allowing the energy storage device to charge the EV chargers at night and be available for use during peak load periods when facility power or local grid power is not available in sufficient amounts to meet needs.

9. The controller of claim 4, wherein said controller, via said energy storage interface, is for allowing the energy storage device to be charged up any instant when sufficient facility power is available.

10. The controller of claim 9, wherein said controller allows both EV charging and energy storage recharging to occur at any time if sufficient electrical supply is available.

11. The controller of claim 4, wherein said controller, via said energy storage interface, is for allowing the energy storage device to provide electricity to EV charging in preference to using facility power when determined optimal.

12. The controller of claim 4, wherein said controller, via said energy storage interface, is for allowing energy stored in the energy storage device to be used in combination with facility power to charge electrical vehicles, thus reducing load that the facility would otherwise see.

13. The controller of claim 4, wherein said controller, via said energy storage interface, is for allowing the energy storage device to be used to power facility systems based on economic criteria, and during some periods, said energy storage interface determines that it is economical to curtail EV charging in whole or in part and export power into the electrical distribution grid, via said distribution grid interface.

14. The controller of claim 4, wherein said controller, via said energy storage interface, in periods of no EV charging demand, is for utilizing the energy storage system to charge the electrical distribution grid, via said distribution grid interface, or use energy for other facility energy uses in preference to paying for power by the electrical distribution grid.

15. The controller of claim 6, wherein said controller, via said renewable energy generation interface, is for adding the renewable energy generation devices on a modular basis, which supplies electricity to charge the electric vehicles, charge batteries, power facility loads, or export power to the electrical distribution grid, via said distribution grid interface.

16. The controller of claim 6, wherein said controller, via said renewable energy generation interface, senses power quality and ensures that said distribution grid interface is not exporting power to the electrical distribution grid or being used in the facility in a manner that would damage electrical equipment.

17. The controller of claim 1, wherein said controller, via said distribution grid interface, is for reacting to electrical supply signals including electrical pricing signals, and local electrical congestion, of the electrical distribution grid.

18. The controller of claim 1, wherein said controller is for acting as an automatic arbitrage for the electrical distribution grid, via said distribution grid interface, and for the facility, via said facility energy management interface, so as to allow the energy storage device, via said energy storage interface, to reduce operational costs, improve reliability of the electrical distribution grid, via said distribution grid interface, and accomplish daily load peak shaving.

19. The controller of claim 1, wherein said controller is for buying and selling electricity depending upon local marginal bus price of electricity.

20. The controller of claim 1, wherein said controller, via said distribution grid interface, is for curtailing energy use by large commercial customers on the electrical distribution grid; and
wherein said controller, via said facility energy management interface, is for curtailing facility loads based on price signals and/or other considerations to reduce localized grid congestion, shave peak loads, and reduce operational costs.

21. The controller of claim 1, wherein said controller, via said EV charger interface, is for maximizing EV charging by curtailing facility load in favor of EV charging loads.

22. The controller of claim 1, wherein said controller, via said EV charger interface, is for maximizing number of electrical vehicles that are charged in a given time period and with a given amount of electrical power supply, via said distribution grid interface and/or said renewable energy generation interface.

23. The controller of claim 1, wherein said controller is for calculating charging order of the electrical vehicles based on customer-provided expected parking durations, current % charge of each electrical vehicle, and available electrical power so as to allow a number of electrical vehicles charged in a given period with a given amount of power to be automated and provide instructions to parking/charging attendants or to automatically coordinate fleets of single chargers installed in the facility.

24. The controller of claim 1, further comprising an identification system; and wherein said identification system is for automatically identifying the electrical vehicles being charged to simplify billing process.

25. The controller of claim 24, wherein said identification system comprises an RFID sender sticker.

26. The controller of claim 25, wherein said RFID sender sticker of said identification system is for holding electrical vehicle owner identification and billing information; and
wherein said RFID sender sticker of said identification system is for placing on the electrical vehicle around a female EV charger connection.

27. The controller of claim 25, wherein said RFID sender sticker of said identification system is for interfacing with an EV charging handle having an RFID receiver that activates said RFID sender sticker when the EV charging handle is inserted into the female EV charger connection, thus identifying each electrical vehicle at point of charging.
